(19) United States
(12) Patent Application Publication
(10) Pub. No.: US 2024/0076495 A1
(43) Pub. Date: Mar. 7, 2024

(54) CURABLE CONDUCTIVE ORGANOPOLYSILOXANE COMPOSITION AND PREPARATION METHOD THEREOF

(71) Applicant: ELKEM SILICONES SHANGHAI CO., LTD., SHANGHAI (CN)

(72) Inventors: Tian CAI, SHANGHAI (CN); Long YANG, SHANGHAI (CN); Xin JIANG, SHANGHAI (CN)

(21) Appl. No.: 18/270,623

(22) PCT Filed: Dec. 30, 2021
(86) PCT No.: PCT/CN2021/143041

§ 371 Date: Jun. 30, 2023

(30) Foreign Application Priority Data
Dec. 30, 2020 (WO) PCT/CN2020/141406

(51) Int. Cl. C08L 83/04; C08J 3/22; C08K 3/04; C08K 3/08; C08K 3/36; C08K 9/02

(52) U.S. Cl. CPC C08L 83/04; C08J 3/226; C08K 3/04; C08K 3/08; C08K 3/36; C08K 9/02; C08J 2383/04; C08J 2427/18; C08K 2003/0862; C08K 2201/001; C08K 2201/005

(57) ABSTRACT

A method is described of preparing a curable conductive polyorganosiloxane composition especially having high content of conductive filler and a curable conductive polyorganosiloxane composition preferably obtained therefrom and a premixed conductive paste. A cured conductive silicone rubber obtained by such curable conductive polyorganosiloxane composition is also described as well as the use thereof, especially in electromagnetic shielding. Also described, are electrical wires and cables including such cured conductive silicone rubber. A higher content of conductive fillers can be loaded while enabling good processability by initially preparing a premixed conductive paste including an organopolysiloxane with specific dynamic viscosity and at least a portion of the conductive fillers, and then mixing the premixed conductive paste with the organopolysiloxane masterbatch including at least one organopolysiloxane A and optionally at least one reinforcing filler to obtain a mixture.

### TECHNICAL FIELD

The present invention relates to a method for preparing a curable conductive organopolysiloxane composition especially having high content of conductive filler. The present invention also relates to a curable conductive organopolysiloxane composition preferably obtained by such method and a premixed conductive paste. The present invention further relates to a cured conductive silicone rubber obtained by curing such curable conductive organopolysiloxane composition especially having high content of conductive filler. The present invention further relates to the use of the cured conductive silicone rubber as electromagnetic shielding element in fields of electronics, automobiles, aerospace, high-speed railway, communication, electric power, medicine and wearable intelligent devices. The present invention further relates to electrical wires or cables comprising such cured conductive silicone rubber.

### BACKGROUND ART

In nowadays, the application of electronic products is becoming more and more extensive. During the working of electronic products, they often cause interference to the external environment, which is called electromagnetic interference (EMI). Such electromagnetic interference and electromagnetic radiation increasingly affect the safe and reliable operation of equipment and people's health. To solve the problem of electromagnetic interference, electromagnetic shielding is necessary. Recently, electromagnetic shielding materials have attracted more attention from scientific researchers.

A commonly used electromagnetic shielding material is conductive silicone rubber, which is obtained by mixing a certain amount of conductive fillers with the base organopolysiloxane component, followed by curing through crosslinking to form the conductive silicone rubber with electromagnetic shielding properties. Conductive fillers such as metal-coated carbon, especially nickel-coated carbon have excellent electromagnetic shielding properties and are widely used in the field of electromagnetic shielding.

In order to prepare curable organopolysiloxane system that is easy to be processed, for example extruded and rolled, the content of the conductive fillers is quite crucial. If the content of conductive fillers is too small, then the final cured product has poor electrical conductivity and thus poor electromagnetic shielding property. If the content of conductive fillers is too high (e.g., more than 60 wt %), then the resulting system before curing is difficult to handle and process due to very high viscosity (typically more than 20 million mPa·s), which may lead to the relatively poor electrical conductivity and mechanical properties of the final cured product. This problem becomes even worse when the base organopolysiloxane component is of high viscosity, such as organopolysiloxane gum. The conductive fillers are difficult to disperse due to the quite high viscosity of organopolysiloxane gum (typically more than 600 000 mPa·s at 25° C.), thus the content of the conductive fillers added is limited in the prior art.

Various attempts have been made to incorporate the conductive filler into the base organopolysiloxane component. In most preparation method prior to date, the conductive fillers are mixed with the base organopolysiloxane component in one-step prior to the addition of other components.

Patent CN102276988A discloses a method for preparing a single-component Ni—C filled highly conductive silicone rubber that is vulcanized by platinum. Wherein the vinyl-terminated polydimethylsiloxane with a viscosity of 5000 to 20000 mPa·s including silica is mixed with the conductive filler composed of 167 to 180 parts of nickel-coated graphite powder with an average particle size of 50 μm to 100 μm and 28 to 30 parts of nickel-coated carbon fiber with a diameter of 7 μm to 10 μm and a length of 100 μm to 200 μm. Such resulting formulation is suitable for further processing. However, the base organopolysiloxane component has very low viscosity which is not suitable for extrusion molding or compression molding.

Patent CN103602072A discloses a conductive silicone rubber for electromagnetic shielding and a preparation method thereof. The conductive filler used comprises 30 to 60 parts of conductive medium including silver particles and 30 to 60 parts of magnetic medium including nickel particles. The resulting mixture is mixed on a two-roller mill at a temperature of 50° C. to 150° C. for 0.5 to 1.5 hours. This method relates to a hydroxy silicone rubber with isocyanate as crosslinking agent, which is different from peroxide curing system or addition reaction system of vinyl silicone rubber.

Patent CN105131612A discloses a preparation method of self-adhesive conductive silicon rubber for electromagnetic shielding. 50 to 85 parts of the conductive filler used includes conductive carbon black, nickel-coated graphite, and nickel-coated glass beads, silver aluminum powder, silver coated glass beads, etc. This mixture is prepared on a two-roller mill and subjected to peroxide vulcanization. It just highlights the acceptance of self-adhesion and electromagnetic shielding performance. It didn't disclose the detail of process.

Patent CN103496228A discloses an electromagnetic shielding silicone rubber including a double-layer or multilayer structure and a preparation method thereof. The conductive filler used includes 59% to 64% mass fraction of nickel-coated graphite, nickel-coated aluminum powder, and nickel powder. The good electromagnetic shielding effect is obtained through the composite structure of multilayer conductive silicone rubber. However, the type of the raw materials and the conductivity of the finished product was not disclosed.

Another patent CN107964247A discloses a process using a carbon nanotube mixture comprising carbon nanotubes and poly-organosilicon in a ratio of 1:(0.05 to 0.20). All the carbon nanotubes used was added in the form of carbon nanotubes mixture. Such one-step mixing process may need higher temperature and more time to mix uniformly.

As can be seen from the above, the prior art methods for preparing the curable conductive organopolysiloxane composition are not completely satisfactory in terms of processing. Thus, there still a need for an improved method to overcome the defects of the prior art.

### CONTENTS OF INVENTION

A purpose of the present invention is therefore to provide a method for preparing such curable conductive organopolysiloxane composition especially having high content of conductive fillers without negative effect on the processability, especially for extrusion molding, calendaring molding, and compression molding. Thereby, the resulting cured conductive silicone rubber could exhibit a superior electrical conductivity and electromagnetic shielding properties as well as mechanical properties.

The applicant has surprisingly found that a higher content of conductive fillers could be loaded while enabling good processability by initially preparing a premixed conductive paste comprising an organopolysiloxane C with specific dynamic viscosity as described herein and at least a portion of the conductive filler B, following by mixing the premixed conductive paste with the organopolysiloxane masterbatch comprising at least one organopolysiloxane A and optionally at least one reinforcing filler to obtain a mixture. Such premixed conductive paste functions to disperse the conductive fillers thoroughly, which can reduce the difficulty in handling the curable conductive organopolysiloxane composition with higher content of conductive filler.

In a first aspect, the present invention relates to a method for preparing a curable conductive organopolysiloxane composition especially having high content of conductive filler, comprising the steps of:
(i) mixing at least a portion of the conductive filler B with an organopolysiloxane C with dynamic viscosity in the range from 1000 mPa·s to 400000 mPa·s, preferably from 10000 to 200000 mPa·s, more preferably from 50000 to 150000 mPa·s at 25° C. to obtain a premixed conductive paste;
(ii) mixing the premixed conductive paste obtained in step (i) with the organopolysiloxane masterbatch comprising at least one organopolysiloxane A and optionally at least one reinforcing filler to obtain a mixture.

Preferably, the content of the total conductive filler B in the curable conductive organopolysiloxane composition is from 40 wt % to 80 wt %, preferably from 50 wt % to 80 wt %, more preferably from 60 wt % to 80 wt %, still preferably from 50 wt % to 75 wt %, still more preferably from 60 wt % to 75 wt %, and even more preferably from 65 wt % to 70 wt %, based on the total weight of the curable conductive organopolysiloxane composition.

### Premixed Conductive Paste

In step (i) of the present invention, a premixed conductive paste is prepared by mixing at least a portion of the conductive filler B with an organopolysiloxane C having specific dynamic viscosity in order to disperse the conductive filler homogeneously.

In a preferred embodiment, the organopolysiloxane C as described herein has a dynamic viscosity from 1000 mPa·s to 400000 mPa·s, preferably from 10000 to 200000 mPa·s, more preferably from 50000 to 150000 mPa·s at 25° C. If the dynamic viscosity of the organopolysiloxane C is too low, the final resulting mixture may be too sticky and thus leads to poor handling. If the dynamic viscosity of the organopolysiloxane C is too high, the difficulty in processing would become higher with the amount of conductive filler added increased.

All the viscosities as used herein correspond to a “Newtonian” dynamic viscosity at 25° C., i.e., the dynamic viscosity which is measured, in a manner that is known per se, with a Brookfield viscometer at a shear rate gradient that is low enough for the measured viscosity to be independent of the rate gradient.

As used herein, “organopolysiloxane C” with a specified dynamic viscosity as mentioned above refers to a polymer having a main chain composed of alternating silicon and oxygen atoms, which may have optionally pendant groups bonded thereto such as alkyl (e.g., methyl) and/or substituted alkyl group, as long as its viscosity falls within the above-mentioned specific range. Such organopolysiloxane C may be linear, cyclic or branched polymers or oligomers of silicon/oxygen (organosiloxane) monomers, optionally with some other functional groups such as optionally substituted hydrocarbon radical, preferably C₁-C₁₀ hydrocarbon radical, and more preferably selected from among the group formed by a methyl, ethyl, propyl, 3,3,3-trifluoropropyl, vinyl, xylyl, tolyl and phenyl group. According to a preferred embodiment, the organopolysiloxane C does not contain SiH group and/or hydroxyl group.

In a further preferred embodiment, the organopolysiloxane C with a specified dynamic viscosity as mentioned herein may in particular be silicone oil, which usually refers to a polysiloxane compound that maintains a liquid state at room temperature with Si—O—Si as the main chain. Such silicone oil may have a general formula (I) represented by:

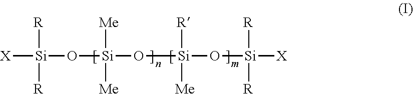

In the above general formula (I),
Me denotes methyl radical,
R, R′ and X, each of which may be identical or different, represent, independently of each other:
   a linear or branched alkyl radical containing 1 to 8 carbon atoms, optionally substituted with at least one halogen, preferably fluorine, the alkyl radicals preferably being methyl, ethyl, propyl, octyl and 3,3,3-trifluoropropyl,
   a cycloalkyl radical containing between 5 and 8 cyclic carbon atoms,
   an aryl radical containing between 6 and 12 carbon atoms, or
   an aralkyl radical bearing an alkyl part containing between 5 and 14 carbon atoms and an aryl part containing between 6 and 12 carbon atoms, preferably, all of R, R′ and X exclude hydroxyl group and/or hydrogen;
each of n and m may be an integer from 100 to 4000, preferably from 500 to 3000.

Depending on the difference between R and R′, silicone oil is classified into two categories: linear silicone oil and modified silicone oil. Linear silicone oils include non-functional silicone oils and silicon functional silicone oils. Among them, non-functional silicone oil refers to a silicone oil in which the substituents on the silicon atom are all inactive hydrocarbon groups, for example dimethyl silicone oil, diethyl silicone oil or methyl phenyl silicone oil etc. Silicon functional silicone oil refers to the silicone oil with functional groups bonded directly to some of the silicon atoms, for example, vinyl silicone oil etc.

In addition, modified silicone oil can be regarded as a liquid polymer wherein some of the hydrocarbon groups bonded to silicon atoms in the non-functional silicone oil molecule are replaced by carbon functional groups or polymer chains, or wherein silicon heterochains are embedded in the molecule. Such modified silicone oil may usually be carbon-functional silicone oil, copolymer silicone oil and main chain modified silicone oil. Among them, carbon-functional silicone oil refers to a silicone oil wherein substituents on some of the silicon atoms are carbon-functional groups, for example epoxyalkyl silicone oil, methacryloxyalkyl silicone oil, mercaptoalkyl silicone oil, chloroalkyl silicone oil, cyanoalkyl silicone oil, etc. While the copolymer silicone oil refers to silicone oil containing polymer chains on the silicon atom, for example polyether silicone oil, long-chain alkyl silicone oil, long-chain alkoxy silicone oil, fluoroalkyl silicone oil, etc. In addition, the main chain modified silicone oil refers to a liquid organic polymer wherein the main chain of the molecule contains a certain degree of silicon hybrid chain besides Si—O—Si bonds, for example silazane silicone oil, silicon alkylene silicone oil, silicon arylene silicone oil etc.

Advantageously, the silicone oil as used herein may be methyl silicone oil or vinyl silicone oil. In the case of vinyl silicone oil, the vinyl content is greater than 0 wt % to 1 wt %, preferably greater than 0 wt % to 0.5 wt %, more preferably greater than 0 wt % to 0.2 wt %, based on the total weight of the vinyl silicone oil.

In a further preferred embodiment, the content of the organopolysiloxane C described herein in the curable conductive organopolysiloxane composition is from 5 wt % to 40 wt %, preferably from 8 wt % to 35 wt %, more preferably from 10 wt % to 30 wt %, based on the total weight of the curable conductive organopolysiloxane composition. If the content of the organopolysiloxane C described herein is more than 40 wt %, it would be too sticky to be processed.

In a still further preferred embodiment, at least a portion of the conductive filler B may be mixed with the organopolysiloxane C having specific dynamic viscosity mentioned herein for 10 to 60 mins, preferably 20 to 40 mins, more preferably 30 mins at the temperature below 80° C., preferably below 70° C., more preferably below 60° C. to obtain the premixed conductive paste.

### Conductive Filler

The at least one conductive filler B used in the present invention may be any materials known in the art suitable for electrical conduction, especially for electromagnetic shielding, such as alumina, aluminum powder, iron powder, nickel powder, copper powder, silver powder, gold powder, graphite, carbon black, as well as metal-coated carbon etc.

In a preferred embodiment, the conductive filler B used in the present invention is composed of one or more of metal-coated carbon and/or carbon black, preferably metal-coated graphite and/or carbon black, more preferably Ni-coated graphite and/or carbon black. Further, the metal is selected from silver, copper and/or nickel.

In another preferred embodiment, the conductive filler B used in the present invention has the particle size of 20 μm to 200 μm, preferably 30 μm to 180 μm, more preferably 50 μm to 150 μm.

In another preferred embodiment, the shape of the conductive filler B used in the present invention may be selected from flat, fibrous, sphere or a combination thereof, preferably flat or fibrous, or a combination thereof.

The content of the total conductive filler B in the premixed conductive paste is no more than 80 wt %, preferably up to 75 wt %, more preferably up to 70 wt %, based on the total weight of premixed conductive paste.

The content of the total conductive filler B in the curable conductive organopolysiloxane composition is from 40 wt % to 80 wt %, preferably from 50 wt % to 80 wt %, more preferably from 60 wt % to 80%, still preferably from 50 wt % to 75 wt %, still more preferably from 60 wt % to 75 wt %, and even more preferably from 65 wt % to 70 wt %, based on the total weight of the curable conductive organopolysiloxane composition.

In a further preferred embodiment, all the conductive filler B described herein may be added during the step (i) of the present invention, or otherwise a portion of the conductive filler B may be added during step (i) while the remaining portion of the conductive filler B may be added during step (iii) as described below.

### Organopolysiloxane Masterbatch

The organopolysiloxane masterbatch used in the step (ii) of the present invention may comprise at least one organopolysiloxane A and optionally at least one reinforcing filler. The organopolysiloxane A may comprise at least one organopolysiloxane A′ and optional at least one organopolysiloxane A″ as defined hereinbelow.

In a preferred embodiment, the organopolysiloxane A′ may be an organopolysiloxane gum substituted with at least two C₂ to C₆ alkenyl substituents.

In a preferred embodiment, the organopolysiloxane A is composed of the at least one organopolysiloxane A′ which is an organopolysiloxane gum having a consistency at 25° C. of between 200 mm/10 and 2000 mm/10, preferably between 300 mm/10 and 1800 mm/10, more preferably between 500 mm/10 and 1500 mm/10.

In a further preferred embodiment, the organopolysiloxane gum may exhibit a dynamic viscosity greater than 600000 mPa·s at 25° C., preferably greater than 1000000 mPa·s at 25° C.

In a still further preferred embodiment, the organopolysiloxane gum may have an alkenyl content between 0.001% to 8 wt %, preferably 0.01% to 4.5 wt %, more preferably 0.03% to 3 wt %, based on the total weight of the organopolysiloxane gum.

In a yet further embodiment, the organopolysiloxane gum may have a weight average molecular weight Mw between 260000 g/mol and 1000000 g/mol, preferably between 400000 g/mol and 1000000 g/mol, and more preferably between 500000 g/mol and 800000 g/mol. The weight-average molecular weight Mw is determined by gel permeation chromatography with polystyrene as standard.

In a further embodiment, the organopolysiloxane A used in the present invention comprises at least one organopolysiloxane A′ which is the organopolysiloxane gum as defined above, and at least one organopolysiloxane A″ which is an oil having a dynamic viscosity of 15 to 50 mPa·s at 25° C., preferably 20 to 40 mPa·s at 25° C. The organopolysiloxane A″ may be linear or branched and may have hydroxy content of 2 wt % to 12 wt %, preferably 4.5% to 9.8 wt %, based on the total weight of component A″.

As used herein, the consistency or penetrability of a gum is determined at 25° C. by means of a penetrometer of PNR12 type or equivalent model which makes it possible to apply, to the sample, a cylindrical head under standardized conditions. The penetrability of a gum is the depth, expressed in tenths of a millimeter, to which a calibrated cylinder penetrates into the sample over one minute. To this end, a sample of gum is introduced into an aluminum receptacle with a diameter of 40 mm and with a height of 60 mm. The cylindrical head, made of bronze or of brass, measures 6.35 mm in diameter and 4.76 mm in height and is carried by a metal rod with a length of 51 mm and with a diameter of 3 mm which fits the penetrometer. This rod is ballasted with an excess load of 100 g. The total weight of the assembly is 151.8 g, including 4.3 g for the cylindrical part and its support rod. The receptacle containing the sample of gum is placed in the bath thermostatically controlled at 25±0.5° C., for at least 30 mins. The measurement is carried out by following the instructions of the manufacturer. The values of the depth (V), in tenths of a millimeter, and of the time (t), in seconds, to reach this depth are shown on the device. The penetrability is equal to 60 V/t, expressed in tenths of a millimeter per minute.

In a preferred embodiment, the at least one organopolysiloxane A may comprise:
(I) at least two siloxyl units of formula (A1):

(Y)ₐ(Z)_{b}SiO_{(4-(a+b))/2} (A1)
in which:
   Y represents a monovalent radical containing from 2 to 6 carbon atoms, having at least two alkenyl group;
   Z represents a monovalent radical containing from 1 to 20 carbon atoms and not comprising an alkenyl group;
   a and b represent integers, a being 1, 2 or 3, b being 0, 1 or 2 and (a+b) being 1, 2 or 3;
(ii) and may optionally comprise other siloxyl units of formula (A2):

(Z)_{c}SiO_{(4-c)/2} (A2)
in which:
   Z has the same meaning as above, and
   c represents an integer which is 1, 2 or 3.

According to the present invention, it is judicious that, for definition of the organopolysiloxane A in the formula (A1), the symbol a can preferably be equal to 1 or 2, and even more preferentially 1. Furthermore, in formula (A1) and in formula (A2), the symbol Z may preferentially represent a monovalent radical chosen from the group formed by an alkyl group containing 1 to 8 carbon atoms, optionally substituted with at least one halogen atom, and a C₆ to C₁₀ aryl group. Z may advantageously represent a monovalent radical chosen from the group consisting of: methyl, ethyl, propyl, 3,3,3-trifluoropropyl, xylyl, tolyl and phenyl. In addition, in formula (A1), the symbol Y may advantageously represent a radical chosen from the group consisting of vinyl, propenyl, 3-butenyl and 5-hexenyl. Preferably, the symbol Y is a vinyl and the symbol Z is a methyl.

The organopolysiloxane A may have a linear or branched structure, preferably a linear structure. When it is linear organopolysiloxane, it can essentially consist:
of siloxyl units “D” chosen from the units of formulae (Y)₂SiO_{2/2}, (Y)(Z)SiO_{2/2} and (Z)₂SiO_{2/2}; and
of siloxyl units “M” chosen from the units of formulae (Y)₃SiO_{1/2}, (Y)₂(Z)SiO_{1/2}, (Y)(Z)₂SiO_{1/2} and (Z)₃SiO_{2/2},
in each formula, the symbols Y and Z are as defined above.

Preferably, the linear organopolysiloxane A has a polymerization degree in a range of 2000 to 10000, more preferably 2000 to 8000 and more preferably 2000 to 5000.

By way of examples for units “D”, mention may be made of dimethylsiloxy, methylphenylsiloxy, methylvinylsiloxy, methylbutenylsiloxy, methylhexenylsiloxy, methyldecenylsiloxy and methyldecadienylsiloxy groups.

By way of example for units “M”, mention may be made of trimethylsiloxy, dimethylphenylsiloxy, dimethylvinylsiloxy and dimethylhexenylsiloxy groups.

The organopolysiloxane A, in particular when it is linear, may be a polymer preferably having a weight average molecular weight Mw between 400 000 g/mol and 1 000 000 g/mol, and preferentially between 600 000 g/mol and 900 000 g/mol.

As examples of organopolysiloxane A used in the present invention, mention may be made of:
polydimethylsiloxanes comprising dimethylvinylsilyl end groups;
poly(methylphenylsiloxane-co-dimethylsiloxane)s comprising dimethylvinylsilyl end groups;
poly(vinylmethylsiloxane-co-dimethylsiloxane)s comprising dimethylvinylsilyl end groups;
poly(dimethylsiloxane-co-vinylmethylsiloxane)s comprising trimethylsilyl end groups;

The organopolysiloxane A which are polydimethylsiloxanes comprising dimethylvinylsilyl end groups having a weight average molecular weight Mw of between 260 000 g/mol and 1 000 000 g/mol, and preferably of between 600 000 g/mol and 900 000 g/mol, are particularly advantageous. The organopolysiloxane A which are particularly advantageous are those of formula M^{Vi}DₐM^{Vi} in which:
M^{Vi}=siloxyl unit of formula: (vinyl)(CH₃)₂SiO_{1/2}
D=siloxyl unit of formula: (CH₃)₂SiO_{2/2}, and
a is a number between 2000 and 10 000, and preferably between 4 000 and 6 000.

In order to describe the organopolysiloxane, the nomenclature known in the field of silicones is applied, which uses the letters of M, D, T and Q to describe siloxy units. The letter M represents the monofunctional unit of formula (R)₃SiO_{1/2}, the silicon atom being connected to just one oxygen atom in the polymer comprising this unit. The letter D means a difunctional unit (R)₂SiO_{2/2} in which the silicon atom is connected to two oxygen atoms. The letter T represents a trifunctional unit of formula (R)SiO₃/2, in which the silicon atom is connected to three oxygen atoms. The letter Q represents a trifunctional unit of formula SiO_{4/2} in which the silicon atom is connected to four oxygen atoms. The M, D and T units can be functionalized. Reference is then made to M, D and T units, while specifying the specific radicals. Generally, the symbol R is chosen from the group consisting of: linear or branched alkyl radicals, such as, for example, methyl, ethyl, propyl, isopropyl, butyl, isobutyl, t-butyl, n-pentyl or n-hexyl; C₃-C₈ cycloalkyl radicals, such as, for example, cyclopentyl or cyclohexyl; aryl radicals, such as, for example, phenyl or naphthyl; and alkylaryl radicals, such as, for example, tolyl or xylyl.

Preferably, the organopolysiloxane A may be selected from dimethylvinyl-terminated polydimethylsiloxane, dimethylvinyl-terminated polydimethylmethylvinylsiloxane, trimethyl-terminated polydimethylmethylvinylsiloxane, more preferably selected from dimethylvinyl-terminated polydimethylsiloxane.

In one embodiment, the content of the organopolysiloxane A is from 0.1 wt %-40 wt %, preferably from 1 wt % to 30 wt %, more preferably from 4 wt % to 25 wt %, based on the total weight of the curable conductive organopolysiloxane composition. When the organopolysiloxane A used in the present invention comprises the organopolysiloxane A′ and organopolysiloxane A″ mentioned before, the content of the organopolysiloxane A′ is from 0.1 wt % to 35 wt %, preferably from 1 wt % to 25 wt %, more preferably from 4 wt % to 15 wt %, and the content of the organopolysiloxane A″ ranges from 0 wt % to 5 wt %, preferably from 0.2 to 2 wt %, more preferably from 1 wt % to 2 wt %, based on the total weight of the curable conductive organopolysiloxane composition.

In a preferred embodiment, the organopolysiloxane masterbatch used in the present invention may optionally comprise at least one reinforcing filler such as silicon oxides and/or diatomaceous earth and the like. The silicon oxides are generally selected from non-treated silica and/or the fumed silica and/or the precipitated silica. Such silica may have a specific surface area, measured by the BET methods, of at least 20 m²/g, preferably above 100 m²/g, more preferably 150 to 300 m²/g. The content of silica is from 0 wt % to 15 wt %, preferably from 2 wt % to 10 wt %, based on the total weight of the curable conductive organopolysiloxane composition.

These silicas may be incorporated preferably as they are or after being treated with organosilicon compounds usually employed for intended use. These compounds include methylorganopolysiloxane such as hexamethyldisiloxane, octamethylcyclotetrasiloxane, decamethylcyclopentasiloxane, methylpolysilazanes such as hexamethyldisilazane, hexamethylcyclotrisilazane, chlorosilanes such as dimethyldichlorosilane, trimethylchlorosilane, methylvinyldichlorosilane, dimethylvinylchlorosilane, alkoxysilanes such as dimethyldimethoxysilane, dimethylvinylethoxysilane, trimethylmethoxysilane.

In a preferred embodiment, the organopolysiloxane masterbatch may be prepared by initially mixing the at least one organopolysiloxane A and the optionally reinforcing filler until a mixture is formed, followed by raising the temperature to 140-160° C., more preferably 150° C. and maintained for 1 to 3 hours, preferably 2 hours, and then the resulting mixture is vacuumed for 1 to 2 hours, preferably 0.5 hours at 140° C. to 160° C., more preferably 150° C. and then cooled to 60° C. to 90° C., more preferably 80° C.

In one embodiment, the method for preparing the curable conductive organopolysiloxane composition in accordance with the first aspect of the present invention further comprises a step (iii) of adding the remaining portion of the conductive filler B to the mixture obtained in step (ii), preferably in batch-wise manner. Thus, the method for preparing the curable conductive organopolysiloxane composition may comprises the steps of:
(i) mixing a portion of the conductive filler B with an organopolysiloxane C with dynamic viscosity in the range from 1000 mPa·s to 400000 mPa·s, preferably from 10000 to 200000 mPa·s, more preferably from 50000 to 150000 mPa·s at 25° C. to obtain a premixed conductive paste;
(ii) mixing the premixed conductive paste obtained in step (i) with the organopolysiloxane masterbatch comprising at least one organopolysiloxane A and optionally at least one reinforcing filler to obtain a mixture,
(iii) adding the remaining portion of the conductive filler B to the mixture obtained in step (ii), preferably in batch-wise manner,
wherein the content of the total conductive filler in the curable conductive organopolysiloxane composition is from 40 wt % to 80 wt %, preferably from 50 wt % to 80 wt %, more preferably from 60 wt % to 80 wt %, still preferably from 50 wt % to 75 wt %, still more preferably from 60 wt % to 75 wt %, and even more preferably from 65 wt % to 70 wt %, based on the total weight of the curable conductive organopolysiloxane composition.

The content of the components used are described as hereinbefore. The step (iii) may be carried out under common process conditions.

The applicant has surprisingly found that such two-stage addition of conductive filler B can improve the dispersion of the conductive filler B and simplify the processability and thus achieve better properties in terms of electrical conductivity, electromagnetic shielding property as well as mechanical property, compared to the conventional methods involving mixing the conductive filler with the base organopolysiloxane component only one time prior to the addition of other components.

In a preferred embodiment, the method for preparing the curable conductive organopolysiloxane composition in accordance with the first aspect of the present invention further comprises a step (iv) of adding a green strength modifier D to the mixture obtained in step (ii) or step (iii) in order to adjust the green strength thereof.

Thus, the method for preparing the curable conductive organopolysiloxane composition may comprise the steps of:
(i) mixing at least a portion of the conductive filler B with an organopolysiloxane C with dynamic viscosity in the range from 1000 mPa·s to 400000 mPa·s, preferably from 10000 to 200000 mPa·s, more preferably from 50000 to 150000 mPa·s at 25° C. to obtain a premixed conductive paste;
(ii) mixing the premixed conductive paste obtained in step (i) with the organopolysiloxane masterbatch comprising at least one organopolysiloxane A and optionally at least one reinforcing filler to obtain a mixture,
(iii) optionally adding the remaining portion of the conductive filler B to the mixture obtained in step (ii), preferably in batch-wise manner,
(iv) adding a green strength modifier D to the mixture obtained in step (ii) or step (iii) in order to adjust the green strength thereof,
wherein the content of the total conductive filler in the curable conductive organopolysiloxane composition is from 40 wt % to 80 wt %, preferably from 50 wt % to 80 wt %, more preferably from 60 wt % to 80 wt %, still preferably from 50 wt % to 75 wt %, still more preferably from 60 wt % to 75 wt %, and even more preferably from 65 wt % to 70 wt %, based on the total weight of the curable conductive organopolysiloxane composition.

Further, the content of the green strength modifier D added is from 0.1 wt % to 2.0 wt %, preferably from 0.5 wt % to 1.5 wt %, more preferably 0.8 wt % to 1.2 wt %, based on the total weight of the curable conductive organopolysiloxane composition. Preferably, the green strength modifier D is selected from polytetrafluoroethylene, carbon nanotubes and H₃BO₃, typically in a powder form. The powder may have a particle size ranging from 1 μm to 50 μm, preferably 5 μm to 20 μm. More preferably, the green strength modifier D is polytetrafluoroethylene, such as those commercially available from DuPont under the name of Zonyl™ MP 1000 with particle size of 12 μm. The content of the other components used are described as hereinbefore.

It has been found that, the mixture obtained by mixing the premixed conductive paste and the organopolysiloxane masterbatch may still be relatively soft and sticky, which may increase the difficulty in handling by the users and may stick to the equipment such as rollers or kneader. In this circumstance, the applicant has surprisingly found that a green strength modifier D function to adjust the green strength of the mixture to the extent suitable for further processing may be used. Such green strength modifier D may be for example polytetrafluoroethylene (PTFE), which can increase the green strength of the mixture and solve stick problem.

In a yet further embodiment, the method for preparing the curable conductive organopolysiloxane composition in accordance with the first aspect of the present invention further comprises a step (v) of adding at least one organic peroxide E to the mixture obtained in step (ii) or (iii) or (iv), preferably in an amount of below 5 wt %, preferably from 0.5 wt % to 2 wt %, more preferably from 0.8 wt % to 1.6 wt %, based on the total weight of the curable conductive organopolysiloxane composition. If the amount of the at least one organic peroxide E added is too low, the vulcanization will not proceed completely; if the amount of addition is too high, the over-vulcanization might occur.

Thus, the method for preparing the curable conductive organopolysiloxane composition may comprise the steps of:
(i) mixing at least a portion of the conductive filler B with an organopolysiloxane C with dynamic viscosity in the range from 1000 mPa·s to 400000 mPa·s, preferably from 10000 to 200000 mPa·s, more preferably from 50000 to 150000 mPa·s at 25° C. to obtain a premixed conductive paste;
(ii) mixing the premixed conductive paste obtained in step (i) with the organopolysiloxane masterbatch comprising at least one organopolysiloxane A and optionally at least one reinforcing filler to obtain a mixture,
(iii) optionally adding the remaining portion of the conductive filler B to the mixture obtained in step (ii), preferably in batch-wise manner,
(iv) optionally adding a green strength modifier D to the mixture obtained in step (ii) or step (iii) in order to adjust the green strength thereof,
(v) adding at least one organic peroxide E to the mixture obtained in step (ii) or (iii) or (iv),
wherein the content of the total conductive filler in the curable conductive organopolysiloxane composition is from 40 wt % to 80 wt %, preferably from 50 wt % to 80 wt %, more preferably from 60 wt % to 80 wt %, still preferably from 50 wt % to 75 wt %, still more preferably from 60 wt % to 75 wt %, and even more preferably from 65 wt % to 70 wt %, based on the total weight of the curable conductive organopolysiloxane composition.

The content of other components used are described as hereinbefore.

The organic peroxide component E used in the present invention is not specifically limited, as long as it can decompose to generate free oxygen radical. It can be used in pure state, or in the form of being dissolved in an organic solvent or silicon oil. The organic peroxide component consists of at least one peroxide selected from for example di-tert-butyl peroxide, 2,5-dimethyl-2,5-di-tert-butyl peroxyhexane, benzoyl peroxide, 2,4-dichlorobenzoyl peroxide, monochlorobenzoyl peroxide, tert-butyl peracetate, dicumyl peroxide, and 2,5-dimethyl hexane-2,5-diperbenzoate.

In a preferred embodiment, the method for preparing the curable conductive organopolysiloxane composition may comprise the steps of:
(i) mixing a portion of the conductive filler B with an organopolysiloxane C with dynamic viscosity in the range from 1000 mPa·s to 400000 mPa·s, preferably from 10000 to 200000 mPa·s, more preferably from 50000 to 150000 mPa·s at 25° C. to obtain a premixed conductive paste;
(ii) mixing the premixed conductive paste obtained in step (i) with the organopolysiloxane masterbatch comprising at least one organopolysiloxane A and optionally at least one reinforcing filler to obtain a mixture,
(iii) adding the remaining portion of the conductive filler B to the mixture obtained in step (ii), preferably in batch-wise manner,
(iv) adding a green strength modifier D to the mixture obtained in step (ii) or step (iii) in order to adjust the green strength thereof,
(v) adding at least one organic peroxide E to the mixture obtained in step (ii) or (iii) or (iv).
wherein the content of the total conductive filler in the curable conductive organopolysiloxane composition is from 40 wt % to 80 wt %, preferably from 50 wt % to 80 wt %, more preferably from 60 wt % to 80 wt %, still preferably from 50 wt % to 75 wt %, still more preferably from 60 wt % to 75 wt %, and even more preferably from 65 wt % to 70 wt %, based on the total weight of the curable conductive organopolysiloxane composition.

The content of the components used are described as hereinbefore.

### Other Additives

In one embodiment, other additives may be added before or during or after the addition of the organic peroxide component of the present invention. Such one or more additives may be any materials suitable for the intended use, which may be selected from radiation shielding agent, free radical inhibitor, adhesive modifier, flame retardant additive, surfactant, ozone degradation inhibitor, light stabilizer, thixotropic agent, and heat stabilizer etc. In the meantime, other organopolysiloxanes, silicone resins, polyorganosilsesquioxanes and silicone rubber powders can also be used.

In a second aspect, the present invention relates to a premixed conductive paste obtained in step (i) of the method in accordance with the first aspect of the present invention.

In a preferred embodiment, the premixed conductive paste described herein may comprise the conductive filler B in an amount of no more than 80 wt %, preferably up to 75 wt %, more preferably up to 70 wt %, based on the total weight of premixed conductive paste and the organopolysiloxane C with dynamic viscosity in the range from 1000 mPa·s to 400000 mPa·s, preferably from 10000 to 200000 mPa·s, more preferably from 50000 to 150000 mPa·s at 25° C.

In a third aspect, the present invention relates to a curable conductive organopolysiloxane composition especially having high content of conductive filler, preferably obtained by the method in accordance with the first aspect of the present invention.

In a preferred embodiment, the curable conductive organopolysiloxane composition in accordance with the third of the present invention may comprise:
(a) organopolysiloxane masterbatch comprising 0.1 wt % to 40 wt %, preferably from 1 wt % to 30 wt %, more preferably 4 wt % to 25 wt % of at least one organopolysiloxane A and at least one reinforcing filler;
(b) 40 wt % to 80 wt %, preferably 50 wt % to 80 wt %, more preferably 60 wt % to 80 wt %, still preferably 50 wt % to 75 wt %, still more preferably 60 wt % to 75 wt %, and even more preferably 65 wt % to 70 wt % of conductive filler B;
(c) 5 wt % to 40 wt %, preferably 8 wt % to 35 wt %, more preferably 10 wt % to 30 wt % of organopolysiloxane C with dynamic viscosity in the range from 1000 mPa·s to 400000 mPa·s, preferably from 10000 to 200000 mPa·s, more preferably from 50000 to 150000 mPa·s at 25° C.;
(d) 0 wt % to 2.0 wt %, preferably 0.1 wt % to 2.0 wt %, more preferably 0.5 wt % to 1.5 wt %, most preferably 0.8 wt % to 1.0 wt % of green strength modifier D;
(e) 0.5 wt % to 2 wt %, preferably 0.8 wt % to 1.6 wt % of organic peroxide E;
wherein all the weight is based on the total weight of the curable conductive organopolysiloxane composition.

In a fourth aspect, the present invention relates to a cured conductive silicone rubber obtained by curing the curable conductive organopolysiloxane composition especially having high content of conductive filler in accordance with the third aspect of the present invention.

The cured conductive silicone rubber may be obtained by heating the curable conductive organopolysiloxane composition at the temperatures ranges from 100° C. and 200° C., and if necessary, from 100° C. to 250° C.

In a fifth aspect, the present invention relates to use of the cured conductive silicone rubber in accordance with the fourth aspect of the present invention as electromagnetic shielding element in fields of electronics, automobiles, aerospace, high-speed railway, communication, electric power, medicine and wearable intelligent devices.

In a sixth aspect, the present invention relates to electrical wires or cables comprising the cured conductive silicone rubber in accordance with the fourth aspect of the present invention.

By “electric wires”, it means an electrical engineering component for conveying electricity, in order to transmit energy or information, and which consists of a material that conducts electricity, single-core or multicore, surrounded by an insulating covering. The interior of an electric wire is called the “core” of the wire.

By “electric cables”, it means an electrical engineering component for conveying electricity, in order to transmit energy or information, and which consists of several conductors that are electrically separate and mechanically integral, optionally with external screening.

An electric cable consists of one or more single conductor(s) (generally based on copper or aluminum); each of these single conductors is protected by a covering or primary insulation made of one or more concentric layer(s) based on an insulator. Around this covering or these coverings (in the case of a cable with several individual conductors), one or more filling element(s) and/or one or more reinforcing element(s) is/are provided, notably based on glass fibers and/or mineral fibers. Then an outer sheath, which may comprise one or more sheath(s), is most often present. In the case of an electric cable with several single conductors, the filling element or elements and/or the reinforcing element or elements, which is (are) arranged around the single conductors (each provided with its primary insulation), constitute(s) a common covering for all the single conductors.

While particular embodiments are described herein, one of ordinary skill in the art will recognize that various other combinations of elements are possible and will fall within the general inventive concepts. The present invention is further illustrated by the following examples not intended to be limited.

### SPECIFIC MODE FOR CARRYING OUT THE INVENTION

### Examples

The raw materials used in all examples of the present invention were listed in Table 1 below.

TABLE 1
The Raw Material Used in the Examples

| Material code | Cas No. | Structure formula |
|---|---|---|
| A1 Vinyl dimethylpolysiloxane | | ViMe₂Si—(SiMe₂)m—SiMe₂Vi |
| | | Vinyl content: 0.08% |
| | | Dynamic viscosity: 100000 mPa · s |
| A2 Vinyl dimethylpolysiloxane | 67762-94-1 | Me₃Si—(SiMe₂)—(SiMeVi)m—SiMe₃, |
| | | Consistency: 800 mm/10 |
| A3 Vinyl dimethylpolysiloxane | 68083-19-2 | ViMe₂Si—(SiMe₂)n—SiMe₂Vi |
| | | Consistency: 900 mm/10 |
| A6 | 70131-67-8 | OH Me₂Si—Dn—SiMe₂OH, |
| Hydroxyldimethylpolysiloxane | | OH content: 9.1 wt %, |
| | | Viscosity: 31 mPa · s at 25° C. |
| B1 | 112945-52-5 | fumed silica |
| C1 | | Ni, C (Nickel coated graphite) with average particle |
| | | size of 100 μm |
| C2 | | Ni, C (Nickel coated graphite) with average particle |
| | | size of 50 μm |
| C3 | 1333-86-4 | Carbon black |
| D | 9002-84-0 | —(CF₂—CF₂)n—, particle size of 12 μm, Zonyl ™ MP 1000 |
| E | 78-63-7 | (CH₃)₃COOC(CH₃)₂CH₂—CH₂C(CH₃)₂OOC(CH₃)₃ |

Test Method

According to the present invention, after the curable conductive organopolysiloxane composition were prepared, each product was evaluated by the following test method and the results were shown in Table 5 to Table 7.

Processability: it is a measure for the easiness of the resulting mixture to be processed after mixing all the components as listed in Table 3 thoroughly with stirring. If the resulting mixture was an integration with all the components well dispersed therein, it was considered to have acceptable processability. Otherwise, if all the components were still in a separate state, it was considered to be not applicable.

Green Strength: it refers to strength of the curable conductive organopolysiloxane composition in an uncured state (commonly designated as “green strength” in industry). Appearance: it is a measure for the creases and cracks on the surface of the curable conductive organopolysiloxane composition. Such composition was obtained by sufficiently mixing all the components as listed in Table 3, and then extruding the resulting mixture without being cured.

Stick to two-roller mill: it is a measure for whether there were residues on the drum when mixed in a kneader or two-rollers, with the symbol “+” indicating the amount of residue and the symbol “/” indicating the amount of the residue was too high so that the device was unworkable.

Density: the density of the cured conductive silicone rubber was measured according to ISO 2781. Curing condition: at 170° C., for 10 minutes.

Hardness: the hardness of the cured conductive silicone rubber was measured according to ASTM D 2240. Curing condition: at 170° C., for 10 minutes.

Tensile Strength: the tensile strength of the cured conductive silicone rubber was measured according to ISO R37. Curing condition: at 170° C., for 10 minutes.

Elongation at break: the elongation at break of the cured conductive silicone rubber was measured according to ISO R37. Curing condition: at 170° C., for 10 minutes.

Tear Strength: the tear strength of the cured conductive silicone rubber was measured according to ASTM D 624A. Curing condition: at 170° C., for 10 minutes.

Volume resistivity: the volume resistivity of the cured conductive silicone rubber was measured according to GB/T 1410-2006. Test specimen had length of 100 mm, thickness of 2 mm and width of 10 mm.

Electromagnetic shielding effect: the electromagnetic shielding effect of the cured conductive silicone rubber was measured according to GB/T 30142-2013. Curing condition: at 170° C., for 10 minutes.

Preparation of Organopolysiloxane Masterbatch and Premixed Conductive Paste.

Four kinds of systems were previously prepared for further use in the examples of the present invention:

Organopolysiloxane Masterbatch 1:

96 parts of A3, 4 parts of A2, 5 parts of A6 were added into a kneader and mixed for 15 mins. Then 30 parts of 1 were added in 2 to 3 times and mixed. After all materials became a processable integration, the temperature was raised to 150° C. and maintained for 2 hours. After the heating was completed, the mixture was subjected to vacuum for 0.5 hours at 150° C., and then cooled to 80° C. and was taken out, thus the organopolysiloxane masterbatch 1 was obtained.

Organopolysiloxane Masterbatch 2:

93 parts of A3, 7 parts of A2, 10 parts of A6 were added into a kneader and mixed for 15 mins. Then 32 parts of 1 were added in 4 to 5 times and mixed. After all materials became a processable integration, the temperature was raised to 150° C. and maintained for 2 hours. After the heating was completed, the mixture was subjected to vacuum for 0.5 hours at 150° C., and then cooled to 80° C. and was taken out, thus the organopolysiloxane masterbatch 2 was obtained.

Organopolysiloxane Masterbatch 3:

82 parts of A3, 18 parts of A2, 13 parts of A6 were added into a kneader and mixed for 15 mins. Then 52 parts of 1 were added in 4 to 5 times and mixed. After all materials became a processable integration, the temperature was raised to 150° C. and maintained for 2 hours. After the heating was completed, the mixture was subjected to vacuum for 0.5 hours at 150° C., and then cooled to 80° C. and was taken out, thus the organopolysiloxane masterbatch 3 was obtained.

Premixed Conductive Paste 1 (Containing 70% of C1):

30 parts of A1 were added to a planetary mixer, then 70 parts of C1 were charged in 5 to 7 times. After all the materials became a processable integration, continuous mixing for 30 mins below 60° C. Taking out the mixture, thus premixed conductive paste 1 (containing 70% of C1) was obtained.

Premixed Conductive Paste 2 (Containing 70% of C2):

30 parts of A1 were added to a planetary mixer, then 70 parts of C2 were charged in 5 to 7 times. After all the materials became a processable integration, continuous mixing for 30 mins below 60° C. Taking out the mixture, thus premixed conductive paste 2 (containing 70% of C2) was obtained.

Premixed Conductive Paste 3 (Containing C3):

82 parts of A3, 18 parts of A2 were added into a kneader and mixed for 10 mins.

Then 64 parts of C3 were added in 5 to 7 times and mixed. After all materials became a processable integration, continuous mixing for 2 hours below 60° C. Taking out the mixture, thus premixed conductive paste 3 (containing C3) was obtained.

Thus, the composition of each organopolysiloxane masterbatch and premixed conductive paste is listed in Table 2.

TABLE 2
The composition of each organopolysiloxane masterbatch and premixed conductive paste

| | Organopoly- | Organopoly- | Organopoly- | Premixed | Premixed | Premixed |
|---|---|---|---|---|---|---|
| | siloxane | siloxane | siloxane | conductive | conductive | conductive |
| Raw | Masterbatch 1 | Masterbatch 2 | Masterbatch 3 | Paste 1 | Paste 2 | Paste 3 |
| material | wt % | wt % | wt % | wt % | wt % | wt % |
| A3 | 71.00 | 65.70 | 49.48 | — | — | 50.00 |
| A2 | 3.00 | 4.80 | 11.05 | — | — | 10.98 |
| B1 | 22.20 | 22.60 | 31.65 | — | — | — |
| A6 | 3.70 | 7.10 | 7.94 | — | — | — |
| A1 | — | — | — | 30.00 | 30.00 | — |
| C1 | — | — | — | 70.00 | — | — |
| C2 | — | — | — | — | 70.00 | — |
| C3 | — | — | — | — | — | 39.00 |

Preparing the Comparative Examples and Examples Prior to Curing According to the Present Invention:

Comparative Example 1 (C1) and Example 1 (E1) were similarly prepared by the method of Premixed conductive paste 1.

Comparative Example 2 (C2), the curable organopolysiloxane composition used to prepare Example 8 (E8) and Example 11 (E11) were prepared according to the following procedure:

### Comparative Example 2: (C2)

40 parts of organopolysiloxane masterbatch 1 were added into the kneader and mixed for 5 mins. Then 60 parts of C1 were added in 5 to 7 times and mixed. It could not be a processable integration after mixing 2 hours.

Curable Organopolysiloxane Composition Used to Prepare Example 8 (E8):

46.33 parts of premixed conductive paste 1 and 21.1 parts of organopolysiloxane masterbatch 3 were added into the kneader and mixed for 10 mins. Then 32.57 parts of C1 were added in 2 times and mixed. After that, charging 1 part of D, mixing for 30 mins below 60° C. Taking out the mixture, thus the curable organopolysiloxane composition used to prepare Example 8 (E8) was obtained.

Curable Organopolysiloxane Composition Used to Prepare Example 11 (E11):

42.87 parts of premixed conductive Paste 1 and 22.86 parts of organopolysiloxane Paste 3 and 4.29 parts of Masterbatch 1 were added into the kneader and mixed for 15 mins. Then 29.99 parts of C1 were added in 2 times and mixed. After that, charging 1 part of D, mixing for 30 mins below 60° C. Taking out the compound, thus the curable organopolysiloxane composition used to prepare Example 11 (E11) was obtained.

The Examples 2-6 (E2-E6) and the respective curable organopolysiloxane composition used to prepare Comparative Example 3 and 4 (C3 and C4), Example 7, 9-10 (E7, E9-E10) were similarly prepared by the method of Example 8 (E8).

TABLE 3
The composition of the Comparative Examples
C1-C2 and Examples E1-E6 prior to curing

| Raw Material | C1 | E1 | C2 | E2 | E3 | E4 | E5 | E6 |
|---|---|---|---|---|---|---|---|---|
| A1 | 20 | 25 | — | — | — | — | — | — |
| Premixed conductive paste 1 | — | — | — | 85.67 | 46.33 | 46.33 | 46.33 | 46.33 |
| Premixed conductive paste 2 | — | — | — | — | — | — | — | — |
| Premixed conductive paste 3 | — | — | — | — | — | — | — | — |
| Organopolysiloxane masterbatch 1 | — | — | 40 | — | 7.2 | 7.2 | 7.2 | 7.2 |
| Organopolysiloxane masterbatch 2 | — | — | — | 14.3 | — | — | — | — |
| Organopolysiloxane masterbatch 3 | — | — | — | — | 13.9 | 13.9 | 13.9 | 13.9 |
| C1^{a} | 80 | 75 | 60 | 0 | 32.57 | 32.57 | 32.57 | 32.57 |
| D | — | — | — | — | 0 | 0.5 | 1 | 1.5 |

^{a}it represents the amount of conductive filled initially mixed with A1 for C1 and E1; it represents the amount of conductive filler initially mixed with organopolysiloxane masterbatch for C2; it represents the amount of conductive filler added after the mixing of organopolysiloxane masterbatch and premixed conductive paste for E2 to E6

Preparation of Cured Comparative Examples and Examples According to the Present Invention

Finally, each curable organopolysiloxane composition used to prepare Comparative Example 3 and 4 (C3, C4), and Examples 7-11 (E7-E11) was mixed with 0.9 part of E and cured at 170° C. for 10 mins, to obtain the cured conductive silicone rubber.

TABLE 4
The composition of the Comparative Examples
C3-C4 and Examples E7-E11 after curing

| Raw Material | C3 | C4 | E7 | E8 | E9 | E10 | E11 |
|---|---|---|---|---|---|---|---|
| Premixed conductive paste 1 | 71.33 | 26.33 | 28.67 | 46.33 | — | 50 | 42.87 |
| Premixed conductive paste 2 | — | — | — | — | 93 | — | — |
| Premixed conductive paste 3 | — | — | — | — | — | — | 22.86 |
| Organopolysiloxane masterbatch 1 | — | 21.4 | 14.3 | — | — | — | 4.29 |
| Organopolysiloxane masterbatch 2 | 28.67 | — | — | — | — | — | — |
| Organopolysiloxane masterbatch 3 | — | 15.7 | 17.1 | 21.1 | 7.13 | 15 | — |
| C1^{a} | 0 | 36.57 | 39.93 | 32.57 | | 35 | 29.99 |
| C2^{b} | — | — | — | — | 32.57 | — | — |
| D | 1 | 1 | 1 | 1 | 1 | 1 | 1 |
| E | 0.9 | 0.9 | 0.9 | 0.9 | 0.9 | 0.9 | 0.9 |

^{a}conductive filler added after the mixing of organopolysiloxane masterbatch and premixed conductive paste
^{b}conductive filler added after the mixing of organopolysiloxane masterbatch and premixed conductive paste

The processability of the curable organopolysiloxane composition prior to the addition of the peroxides as well as the green strength, appearance and the stick to two-roller mill property were summarized in Table 5 below. The properties of the conductive silicon rubber produced by the present invention were summarized in Table 6 and 7 below.

TABLE 5
The processability of the curable organopolysiloxane composition prior
to the addition of the peroxides and other properties thereof.

| Raw material | C1 | E1 | C2 | E2 | E3 | E4 | E5 | E6 |
|---|---|---|---|---|---|---|---|---|
| A1 | 20 | 25 | 0 | 25.7 | 13.9 | 13.9 | 13.9 | 13.9 |
| A3 | 0 | 0 | 28.4 | 9.39 | 11.99 | 11.99 | 11.99 | 11.99 |
| A2 | 0 | 0 | 1.19 | 0.68 | 1.75 | 1.75 | 1.75 | 1.75 |
| A6 | 0 | 0 | 1.48 | 1.01 | 1.37 | 1.37 | 1.37 | 1.37 |
| B1 | 0 | 0 | 8.89 | 3.23 | 6.0 | 6.0 | 6.0 | 6.0 |
| C1 | 80 | 75 | 60 | 60 | 65 | 65 | 65 | 65 |
| D | 0 | 0 | 0 | 0 | 0 | 0.5 | 1.0 | 1.5 |
| Processability | N/A | Ok | N/A | Ok | Ok | Ok | Ok | Ok |
| Green | / | Too | / | Too | Too | Soft | Ok | Too |
| Strength | | soft | | soft | soft | | | hard |
| Appearance | / | / | / | Ok | Ok | A little | A little | A little |
| Stick to two- | / | ++++++++ | / | +++++ | +++++ | + | + | + |
| roller mill | | | | | | | | |

As can be seen from above, for preparing the premixed conductive paste, the content of the conductive filler in the dimethylvinylsilyl-terminated polydimethylsiloxanes with a specific dynamic viscosity as used herein might not exceed 80 wt %. As shown from Comparative Example 1 (C1), a processable integration could no longer be obtained at such high concentration. Preferably, the content of the conductive filler in the vinyl silicon oil might preferably be up to 75 wt %, as shown from the present Example 1 (E1).

In addition, from the Comparative Example 2 (C2) and Example 2 to 3 (E2-E3), when the content of the conductive filler was more than 60 wt %, a processable integration could still be produced by mixing at least one organopolysiloxane gum with a premixed conductive paste comprising the conductive filler and an organopolysiloxane having a specific dynamic viscosity as used herein. It has been demonstrated that a good processability was achieved even for higher content of the conductive filler by using the preparation method of the present invention.

Furthermore, without adding PTFE powder, the mixtures obtained by Example 2 and 3 were sticky, which were not prone to be processed. As compared, a proper green strength was achieved with the addition of PTFE powder in a specific amount. Thus, the presence of the fluoroethylene has contributed to the adjustment of the green strength.

TABLE 6
The electrical and mechanical properties for the comparative
and the inventive conductive silicon rubber

| Raw material | C3 | C4 | E7 | E8 | E9 | E10 | E11 |
|---|---|---|---|---|---|---|---|
| A1 | 21.4 | 7.9 | 8.6 | 13.9 | 27.9 | 15 | 12.86 |
| A3 | 18.78 | 22.96 | 18.61 | 10.44 | 3.51 | 7.42 | 14.48 |
| A2 | 1.36 | 2.38 | 2.32 | 2.33 | 0.78 | 1.66 | 2.64 |
| A6 | 2.01 | 2.04 | 1.89 | 1.68 | 0.56 | 1.19 | 0.16 |
| B1 | 6.44 | 9.72 | 8.59 | 6.68 | 2.25 | 4.75 | 0.95 |
| C1 | 50 | 55 | 60 | 65 | 0 | 70 | 60 |
| C2 | 0 | 0 | 0 | 0 | 65 | 0 | 0 |
| C3 | 0 | 0 | 0 | 0 | 0 | 0 | 8.91 |
| D | 1.0 | 1.0 | 1.0 | 1.0 | 1.0 | 1.0 | 1.0 |
| E | 0.9 | 0.9 | 0.9 | 0.9 | 0.9 | 0.9 | 0.9 |
| Mechanical properties | | | | | | | |
| Density (g/cm³) | 1.66 | 1.83 | 1.96 | 2.02 | 2.0 | 2.19 | 1.92 |
| Hardness (SHA) | 50 | 65 | 72 | 71 | 61 | 80 | 68 |
| Tensile strength(MPA) | 1.8 | 3.4 | 2.7 | 1.8 | 1.9 | 1.8 | 1.9 |
| Elongation at break (%) | 357 | 397 | 317 | 312 | 361 | 39 | 170 |
| Tear strength (KN/m) | 8.6 | 19.4 | 21.7 | 17 | 16.3 | 16.9 | 14.2 |
| Electrical properties | | | | | | | |
| Volume resistivity | 500 | 220 | 11 | 0.031 | 0.058 | 0.0102 | 0.0154 |
| Ω · cm | | | | | | | |

TABLE 7
Electromagnetic shielding effect for conductive silicon rubber

| Frequency(MHZ) | E8 | E11 |
|---|---|---|
| 30 | 51.3 dB | 51.4 dB |
| 100 | 58.9 dB | 55.8 dB |
| 300 | 66.8 dB | 63.2 dB |
| 915 | 81.8 dB | 78.6 dB |
| 1500 | 92.6 dB | 79.4 dB |
| 1800 | 93.5 dB | 80.8 dB |
| 2450 | 94.8 dB | 81.2 dB |
| 3000 | 95.5 dB | 94.6 dB |
| 5000 | 96.2 dB | 93.5 dB |
| 8000 | 96.8 dB | 94.7 dB |
| 10000 | 97.4 dB | 95.5 dB |

As clearly shown from the Table 6, all the examples of the present invention have achieved a superior electrical conductivity, compared with the Comparative Examples (C3 and C4). Meanwhile, sufficient mechanical properties of the cured silicone rubber of the present invention were also obtained for industry application. Even for Comparative Example C3, it might still be useful for the application where the requirement for electrical conductivity is not too high.

Additionally, the use of carbon black in combination with the nickel-coated graphite could reduce costs and improve conductivity with the electromagnetic shielding performance comparable, as shown from the E8 vs. E11. Due to adjustable mechanical properties, the inventive conductive silicon rubber was applicable for a wide variety of industry applications, such as sealing strip and gaskets for the electronic field. Further, the use of nickel-coated graphite alone as the conductive filler was preferred in terms of the balance between the electrical conductivity, electromagnetic shielding property and the mechanical property.

Regarding the particle size for the conductive filler, it is notable that a good electrical conductivity and mechanical properties could be achieved for both E8 with a particle size of 100 μm and E9 with a particle size of 50 μm. It might be stickier for E9 than for E8, but it can be improved by adjusting the ratio of silica and Zonyl™ MP 1000. Therefore, the particle size of nickel-coated graphite could be in the range from 20 μm to 200 μm.

Furthermore, the scope of the general inventive concepts is not intended to be limited to the particular exemplary embodiments described herein. From the disclosure given, those skilled in the art will not only understand the general inventive concepts and their attendant advantages but will also find apparent various changes and modifications to the methods and products disclosed. It is sought, therefore, to cover all such changes and modifications as fall within the spirit and scope of the general inventive concepts, as described and suggested herein, and any equivalents thereof.

1. A method of preparing a curable conductive polyorganosiloxane composition especially having high content of conductive filler, the method comprising the steps of:
(i) mixing at least a portion of a conductive filler B with an organopolysiloxane C having a dynamic viscosity in the range from 1000 mPa·s to 400000 mPa·s 25° C. to obtain a premixed conductive paste,
(ii) mixing the premixed conductive paste obtained in step (i) with the organopolysiloxane masterbatch comprising at least one organopolysiloxane A and optionally at least one reinforcing filler to obtain a mixture,
wherein the content of the total conductive filler B in the curable conductive polyorganosiloxane composition is from 40 wt % to 80 wt % based on the total weight of the curable conductive polyorganosiloxane composition.

2. The method according to claim 1, wherein the content of the conductive filler B in the premixed conductive paste is no more than 80 wt, based on the total weight of the premixed conductive paste.

3. The method according to claim 1, wherein the organopolysiloxane C is silicone oil having a general formula (I) represented by: 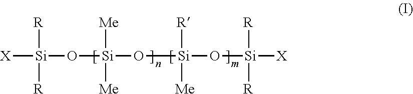
wherein, each R is independently selected from alkyl, aryl; each R′ is independently selected from alkyl, aryl, alkenyl, carbon functional group and polyether segment; each X is independently selected from alkyl, aryl, alkenyl, carbon functional group and polyether segment; each of n and m is an integer from 100 to 4 000.

4. The method according to claim 3, wherein the organopolysiloxane C is selected from the group consisting of methyl silicone oil, ethyl silicone oil, methyl phenyl silicone oil, and modified silicone oil or vinyl silicone oil having a vinyl content of 0 wt % to 1 wt % is preferred.

5. The method according to claim 1, wherein the content of the organopolysiloxane C in the curable conductive polyorganosiloxane composition is from 5 wt % to 40 wt, based on the total weight of the curable conductive polyorganosiloxane composition.

6. The method according to claim 1, wherein the conductive filler B is selected from the group consisting of metal-coated carbon and/or carbon black, and/or the conductive filler B has a particle size of 20 μm to 200 μm.

7. The method according to claim 1, wherein the organopolysiloxane A is an organopolysiloxane gum having a dynamic viscosity greater than 600 000 mPa·s at 25° C., and/or an organopolysiloxane gum having a consistency at 25° C. of from 200 mm/10 to 2000 mm/10.

8. The method according to claim 1, wherein the organopolysiloxane A comprises the first organopolysiloxane A′ which is an organopolysiloxane gum having a dynamic viscosity greater than 600 000 mPa·s at 25° C. and/or an organopolysiloxane gum having a consistency at 25° C. of from 200 mm/10 to 2000 mm/10, and the second organopolysiloxane A″ which is an oil having a dynamic viscosity of 15 mPa·s to 50 mPa·s at 25° C. with hydroxy content of 2 wt % to 12 wt %, based on the total weight of component A″.

9. The method according to claim 1, wherein the content of the organopolysiloxane A is from 0.1 wt % to 40 wt % based on the total weight of the curable conductive polyorganosiloxane composition.

10. The method according to claim 1, further comprising a step (iii) of adding the remaining portion of the conductive filler B to the mixture obtained in step (ii).

11. The method according to claim 1, further comprising a step (iv) of adding a green strength modifier D to the mixture obtained in step (ii) or step (iii) in order to adjust the green strength thereof.

12. The method according to claim 1, wherein the content of the green strength modifier D is from 0.1 wt % to 2.0 wt %, based on the total weight of the curable conductive polyorganosiloxane composition.

13. The method according to claim 1, further comprising a step (v) of adding at least one organic peroxide E to the mixture obtained in step (ii) or (iii) or (iv), preferably in an amount of 0.5 wt % to 2 wt %, more preferably 0.8 wt % to 1.6 wt %, based on the total weight of the curable conductive polyorganosiloxane composition.

14. A premixed conductive paste obtained in the step (i) of the method according to claim 1.

15. A curable conductive polyorganosiloxane composition especially having high content of conductive filler obtained by the method according to claim 1.

16. The curable conductive polyorganosiloxane composition according to claim 15 wherein the composition comprises:
(a) an organopolysiloxane masterbatch comprising 0.1 wt %-40 wt % of at least one organopolysiloxane A and at least one reinforcing filler;
(b) 40 wt % to 80 wt % of conductive filler B;
(c) 5 wt % to 40 wt % of organopolysiloxane C with dynamic viscosity in the range from 1000 mPa·s to 400000 mPa·s at 25° C.;
(d) 0 wt % to 2.0 wt % of green strength modifier D;
(e) 0.5 wt % to 2 wt % of organic peroxide E;
wherein all the weight is based on the total weight of the curable conductive polyorganosiloxane composition.

17. A curable conductive polyorganosiloxane composition especially having high content of conductive filler, wherein the composition comprises the following:
(a) an organopolysiloxane masterbatch comprising 0.1 wt %-40 wt %, of at least one organopolysiloxane A and at least one reinforcing filler;
(b) 40 wt % to 80 wt % of conductive filler B;
(c) 5 wt % to 40 wt % of organopolysiloxane C with dynamic viscosity in the range from 1000 mPa·s to 400000 mPa·s at 25° C.;
(d) 0 wt % to 2.0 wt % of green strength modifier D;
(e) 0.5 wt % to 2 wt % of organic peroxide E;
wherein all the weight is based on the total weight of the curable conductive polyorganosiloxane composition.

18. A cured conductive silicone rubber obtained by curing the curable conductive polyorganosiloxane composition especially having high content of conductive filler according claim 15.

19. A method of making an article, the method comprising making the article with the cured conductive silicone rubber according to claim 18, wherein the article is an electromagnetic shielding element designed for use in electronics, automobiles, aerospace, high-speed railway, communication, electric power, medicine and wearable intelligent devices.

20. An electrical wire or cable comprising the cured conductive silicone rubber according to claim 18.

21. The method according to claim 1, wherein the dynamic viscosity of the organopolysiloxane C is from 10000 mPa·s to 200000 mPa·s.

22. The method according to claim 1, wherein the dynamic viscosity of the organopolysiloxane C is from 50000 mPa·s to 150000 mPa·s

23. The method according to claim 1, wherein the content of the total conductive filler B is from 60 wt % to 75 wt %.

24. The method according to claim 1, wherein the content of the total conductive filler B is from 65 wt % to 70 wt %.

25. The method according to claim 2, wherein the content of the total conductive filler B is no more than 75 wt %.

26. The method according to claim 2, wherein the content of the total conductive filler B is no more than 70 wt %.

27. The method according to claim 3, wherein R excludes hydroxyl group and/or hydrogen.

28. The method according to claim 3, wherein R′ excludes hydroxyl group and/or hydrogen.

29. The method according to claim 3, wherein X excludes hydroxyl group and/or hydrogen.

30. The method according to claim 3, wherein each of n and m is an integer from 500 to 3 000.

31. The method according to claim 4, wherein the vinyl silicone oil has a vinyl content of 0 wt % to 0.5 wt %

32. The method according to claim 4, wherein the vinyl silicone oil has a vinyl content of 0 wt % to 0.2 wt %.

33. The method according to claim 4, wherein the organopolysiloxane C is the vinyl silicone oil has a vinyl content selected from the group consisting of 0 wt % to 1 wt %, 0 wt % to 0.5 wt % or 0 wt % to 0.2 wt %.

34. The method according to claim 5, wherein the content of the organopolysiloxane C is from 8 wt % to 35 wt %.

35. The method according to claim 5, wherein the content of the organopolysiloxane C is from 10 wt % to 30 wt %.

36. The method according to claim 6, wherein the filler B is Ni-coated carbon and/or carbon black.

37. The method according to claim 6, wherein the filler B is Ni-coated graphite and/or carbon black.

38. The method according to claim 6, wherein the filler B has a particle size of 30 μm to 180 μm.

39. The method according to claim 6, wherein the filler B has a particle size of 50 μm to 150 μm.

40. The method according to claim 7, wherein the organopolysiloxane gum has a dynamic viscosity of greater than 1 000 000 mPa·s.

41. The method according to claim 7, wherein the consistency of the organopolysiloxane gum is from 300 mm/10 to 1800 mm/10.

42. The method according to claim 7, wherein the consistency of the organopolysiloxane gum is from 500 mm/10 to 1500 mm/10.

43. The method according to claim 8, wherein the dynamic viscosity of the first organopolysiloxane A′ is greater than 1 000 000 mPa·s.

44. The method according to claim 8, wherein the consistency of the organopolysiloxane gum is from 300 mm/10 to 1800 mm/10.

45. The method according to claim 8, wherein the consistency of the organopolysiloxane gum is from 500 mm/10 to 1500 mm/10.

46. The method according to claim 8, wherein the second polyorganosiloxane A″ oil has a dynamic viscosity of from 20 mPa·s to 40 mPa·s.

47. The method according to claim 8, wherein the second polyorganosiloxane A″ oil has a hydroxy content of from 4.5 wt % to 9.8 wt %.

48. The method according to claim 9, wherein the content of the polyorganosiloxane A is from 1 wt % to 30 wt %.

49. The method according to claim 9, wherein the content of the polyorganosiloxane A is from 4 wt % to 25 wt %.

50. The method according to claim 10, wherein the remaining portion of the conductive filler B is added to the mixture obtained in step (ii) in a batch-wise manner.

51. The method according to claim 12, wherein the content of the green strength modifier D is from 0.5 wt % to 1.5 wt %.

52. The method according to claim 12, wherein the content of the green strength modifier D is from 0.8 wt % to 1.2 wt %.

53. The method according to claim 10, wherein the green strength modifier D is polytetrafluoroethylene.

54. The method according to claim 16, wherein the organopolysiloxane masterbatch comprises from 1 wt % to 30 wt % of the at least are polyorganosiloxane A.

55. The method according to claim 16, wherein the organopolysiloxane masterbatch comprises from 4 wt % to 25 wt % of the at least are polyorganosiloxane A.

56. The composition according to claim 16, wherein the amount of the conductive filler B is from 60 wt % to 75 wt %.

57. The composition according to claim 16, wherein the amount of the conductive filler B is from 65 wt % to 70 wt %.

58. The composition according to claim 16, wherein the amount of the organopolysiloxane C is from 8 wt % to 35 wt %.

59. The composition according to claim 16, wherein the amount of the organopolysiloxane C is from 10 wt % to 30 wt %.

60. The composition according to claim 16, wherein the dynamic viscosity of the organopolysiloxane C is in a range from 1 000 mPa·s to 200 00 mPa·s.

61. The composition according to claim 16, wherein the dynamic viscosity of the organopolysiloxane C is in a range from 50 000 mPa·s to 150 00 mPa·s.

62. The composition according to claim 16, wherein the amount of the green strength modifier D is from 0.1 wt % to 2.0 wt %.

63. The composition according to claim 16, wherein the amount of the green strength modifier D is from 0.5 wt % to 1.5 wt %.

64. The composition according to claim 16, wherein the amount of the green strength modifier D is from 0.8 wt % to 1.2 wt %.

65. The composition according to claim 16, wherein the amount of the organic peroxide E is from 0.8 wt % to 1.6 wt %.

66. The composition according to claim 17, wherein the organopolysiloxane masterbatch comprises from 1 wt % to 30 wt % of the at least are organopolysiloxane A.

67. The composition according to claim 17, wherein the organopolysiloxane masterbatch comprises from 4 wt % to 25 wt % of the at least are organopolysiloxane A.

68. The composition according to claim 16, wherein the amount of the conductive filler B is from 60 wt % to 75 wt %.

69. The composition according to claim 16, wherein the amount of the conductive filler B is from 65 wt % to 70 wt %.

70. The composition according to claim 17, wherein the amount of the organopolysiloxane C is from 8 wt % to 35 wt %.

71. The composition according to claim 17, wherein the amount of the organopolysiloxane C is from 10 wt % to 30 wt %.

72. The composition according to claim 17, wherein the dynamic viscosity of the organopolysiloxane C is in a range from 1 000 mPa·s to 200 00 mPa·s.

73. The composition according to claim 17, wherein the dynamic viscosity of the organopolysiloxane C is in a range from 50 000 mPa·s to 150 00 mPa·s.

74. The composition according to claim 17, wherein the amount of the green strength modifier D is from 0.1 wt % to 2.0 wt %.

75. The composition according to claim 17, wherein the amount of the green strength modifier D is from 0.8 wt % to 1.2 wt %.

76. The composition according to claim 17, wherein the amount of the organic peroxide E is from 0.8 wt % to 1.6 wt %.
